(19) United States
(12) Patent Application Publication
(10) Pub. No.: US 2016/0107375 A1
(43) Pub. Date: Apr. 21, 2016

(54) LAYERED-BODY PRODUCTION METHOD

(71) Applicant: MIMAKI ENGINEERING CO., LTD., Nagano (JP)

(72) Inventors: MASARU OHNISHI, NAGANO (JP); HIRONORI HASHIZUME, NAGANO (JP)

(73) Assignee: MIMAKI ENGINEERING CO., LTD., NAGANO (JP)

(21) Appl. No.: 14/894,996

(22) PCT Filed: Jun. 2, 2014
(86) PCT No.: PCT/JP2014/064641

§ 371 Date: Dec. 1, 2015

(30) Foreign Application Priority Data
Jun. 3, 2013 (JP) 2013-117325

(51) Int. Cl. B29C 65/00; B29C 65/48; B29C 67/00

(52) U.S. Cl. CPC B29C 66/723; B29C 67/0081; B29C 65/4845; B29C 66/72321; B33Y 10/00

(57) ABSTRACT

This invention is directed to favorable transfer of a transfer layer to a three-dimensionally layered ink and improvements in transfer efficiency. To this end, a layered-body production method is provided. The method includes a three-dimensional layer forming step of applying an ink on a base material (1) to form a three-dimensional layer (2), a smoothing step of applying a liquid containing solid matter on the three-dimensional layer (2) to smooth irregularities formed on a surface of the three-dimensional layer (2) before curing, a transfer step of pushing a metallic layer (7) against the surface of the three-dimensional layer (2) subsequent to the smoothing step to transfer the metallic layer (7) to the surface of the three-dimensional layer (2).

### TECHNICAL FIELD

This invention relates to an image formation technology using transfer technique, particularly to a technology to form an image presenting a three-dimensional effect.

### BACKGROUND ART

It is a known art to form images using transfer technique. Taking the formation of a glossy image on a base material for instance, a transfer method that uses a metallic layer as a transfer layer is conventionally employed.

A known method for transfer of the transfer layer such as a metallic layer to a base material may be called foil stamping printing or foil transfer printing with the use of letterpress. The Patent Document 1 describes an image forming method characterized in that a recording medium is brought into contact with an ink image formed on an intermediate transfer medium, the ink image containing an ingredient curable by irradiating the ingredient with an active energy line, to transfer the ink image to the recording medium. This method includes a step of applying an ink to form the ink image using an ink jet head, and a step of, with the recording medium in contact with the ink image on the intermediate transfer medium, irradiating the ink image with the active energy line.

### PRIOR ART DOCUMENT

### Patent Document

Patent Document 1: JP 2010-143073 A (disclosed on Jul. 1, 2010)

### SUMMARY OF THE INVENTION

### Problem to be Solved by the Invention

These conventional methods are directed to the formation of two-dimensional images. To an image presenting a three-dimensional effect by the transfer-based image forming method, for example, embossing may be applied to a base material after a two-dimensional image is transferred thereto, or the two-dimensional image may be transferred to a base material on which a three-dimensional structure is already formed by plastic molding or engraving. These options, however, entail additional labors including engraving, and preparing a mold for embossing or molding, leading to cost increase and tighter delivery-time requirements to be met. These optional methods are, therefore, unsuited for low-volume, high-variety production.

Another possible option is to discharge an ink from an ink jet device in a layered form, and then transfer the metallic layer onto the layered ink. This option, however, involves the problem of poor transfer efficiency on transferring the metallic layer to the ink because the metallic layer is often not transferred well to the ink.

This invention addresses the problems with the prior art and is directed to succeeding in desirable transfer of a transfer layer to the surface of an ink stacked in layers three-dimensionally and improving the transfer efficiency.

### Solutions to the Problem

The conventional methods, when employed to form an image presenting a three-dimensional effect, are costly, requires additional labors including preparing a mold. The inventors of this application came up with the idea of using ink jet technique for the formation of a three-dimensional structure.

The attempt to deposit an ink three-dimensionally and form a transfer layer thereon using an ink jet device, however, involves the problems; poor transfer of the transfer layer to the three-dimensionally deposited ink, and failure to obtain a high-quality transferred material even if the attempt manages to succeed in transfer of the transfer layer to the ink. The inventors continued their searches for ways to transfer the transfer layer well to the ink surface, and arrived at the finding described below.

First, the inventors found that, in the attempt to transfer the transfer layer to the surface of an ink, there were some parts on the ink surface where transfer of the transfer layer was incomplete. The inventors worked on this problem and tracked down the source of such incomplete transfer of the transfer layer. When the ink is discharged by an ink jet device and deposited in layers to form a three-dimensional layer, multiple projections and depressions may be formed on the surface of the three-dimensional layer. The transfer of the transfer layer goes well with the projections but not with the depressions. The inventors earnestly discussed and tried to solve the problem, and then finally accomplished the following method.

A layered-body production method according to this invention provided to solve the problem is a method for producing a layered body including layers of a base material, a three-dimensional layer, and a transfer layer, the method including a three-dimensional layer forming step of applying an ink containing solid matter on the base material to form the three-dimensional layer; a smoothing step of applying a liquid containing solid matter at least once on the three-dimensional layer to smooth irregularities formed on a surface of the three-dimensional layer before curing; and a transfer step of pushing a transfer film including the transfer layer against the surface of the three-dimensional layer subsequent to the smoothing step to transfer the transfer layer to the surface of the three-dimensional layer.

The method thus characterized, by simply applying the ink containing solid matter on the base material, may form the three-dimensional layer three-dimensionally structured on the base material without the need to additionally prepare a mold and the like.

If the three-dimensional layer has projections and depressions on its surface when the three-dimensional layer forming step is over, pushing the transfer film including the transfer layer against the three-dimensional layer fails in complete transfer of the transfer layer. This is fraught with the following problems. On the surface of the three-dimensional layer, the transfer of the transfer layer on their projections goes well, whereas the transfer of the transfer layer on their depressions substantially fails. Supposing that the transfer of the transfer layer to the ink does not fail, a high-quality transferred material may be hardly expected.

According to the method described above, the smoothing step applies the solid matter-containing liquid at least once on the surface of the three-dimensional layer to smooth the irregularities formed on the surface of the three-dimensional layer before curing. When the smoothing step is over, therefore, the three-dimensional layer may have a smoothed surface. By pushing the transfer film including the transfer layer against the smoothed surface of the three-dimensional layer, the transfer layer may be closely adhered to the three-dimensional layer and accordingly transferred well to the surface of the three-dimensional layer. This may provide an image in which the transfer layer is fi adhered to the three-dimensional layer. Further advantageously, there is accordingly no projection or depression formed on the surface of the transferred transfer layer, providing the transfer layer with a smoothed surface.

According to the method described above eliminating the need to prepare a mold and the like, an image presenting a three-dimensional effect may be formed with lower cost or within shorter delivery time.

The layered-body production method according to this invention is preferably further characterized in that the ink is a curable ink containing an ultraviolet curable resin curable by ultraviolet light radiation, and the three-dimensional layer forming step includes forming the three-dimensional layer by, while applying the curable ink on the base material, irradiating the curable ink applied on the base material with ultraviolet light to cure the curable ink.

The method thus characterized may favorably form the three-dimensional layer using the curable ink (UV ink) containing the ultraviolet curable resin. Further advantageously, applying and curing the curable ink are performed substantially concurrently, so that the three-dimensional layer may be formed in a shorter period of time.

The layered-body production method according to this invention is preferably further characterized in that a carriage to be driven in a scan direction is mounted with an ultraviolet irradiation device to irradiate the curable ink with ultraviolet light, and an ink jet head from which the curable ink is to be discharged on the base material, wherein the three-dimensional layer forming step includes, while discharging the curable ink from the ink jet head on the base material, irradiating the curable ink discharged on the base material with ultraviolet light emitted from the ultraviolet irradiation device.

The method thus characterized, by using the ink jet head, may facilitate the formation of the three-dimensional layer in any desired shape. The method may further advantageously facilitate concurrent discharge (applying) and curing of the curable ink.

The layered-body production method according to this invention is preferably further characterized in that the liquid containing solid matter is the curable ink containing the ultraviolet curable resin, and the smoothing step includes discharging on the three-dimensional layer the curable ink from the ink jet head in a quantity required to smooth the irregularities.

According to the method thus characterized, the ink jet head discharges on the three-dimensional layer the curable ink in a quantity required to smooth the irregularities formed on the surface of the three-dimensional layer. This may ensure precise discharge of a predetermined quantity of curable ink, preventing excess of the curable ink on the three-dimensional layer, or shortage of the curable ink that may fail in smoothing the irregularities on the surface of the three-dimensional layer. This may provide an image presenting a three-dimensional effect and having the transfer layer closely adhered to the three-dimensional layer.

The curable ink contains no solvent and primarily consists of an ultraviolet curable resin as solid matter by substantially 100%. After the curable ink is discharged on the three-dimensional layer, therefore, the ingredients of the curable ink are not possibly volatilized. This may allow for speedy smoothing of the irregularities, improving the efficiency of producing a layered body.

The layered-body production method according to this invention is preferably further characterized in that the smoothing step includes irradiating the three-dimensional layer, after being smoothed, with ultraviolet light using the ultraviolet irradiation device.

According to the method thus characterized, the surface of the three-dimensional layer smoothed by the curable ink discharged from the ink jet head is irradiated with ultraviolet light. By thus curing the curable ink discharged on the surface of the three-dimensional layer, the three-dimensional layer having a smoothed surface may be favorably formed.

The layered-body production method according to this invention is preferably further characterized in that the smoothing step includes, after scan of the ink jet head and discharge of the curable ink, performing a plurality of times a step of irradiating the curable ink with ultraviolet light to cure the curable ink.

According to the method thus characterized, the smoothing step performs, after the curable ink is discharged, performs the step of irradiating the curable ink with ultraviolet light to cure the curable ink not just once but a plurality of times. This may lessen by degrees the irregularities formed on the surface of the three-dimensional layer, ultimately smoothing the irregularities formed on the surface of the three-dimensional layer.

By performing the described step more than once to smooth the irregularities on the surface of the three-dimensional layer, the curable ink discharged in one round of the step repeatedly performed may be reduced as compared to the curable ink discharged in the step performed just once to smooth the surface of the three-dimensional layer. This may reduce the ink to be irradiated with ultraviolet light at a time, allowing the use of ultraviolet light with a weaker intensity to cure the curable ink. This may be a great advantage that prevents sink marks (dents formed on surface by curing-induced volume shrinkage) that may otherwise be formed on the surface of the three-dimensional layer.

The layered-body production method according to this invention is preferably further characterized in that the transfer step includes disposing the base material and the transfer film on each other, placing the base material and the transfer film disposed on each other in a container at least partly flexible, and depressurizing interior of the container to force a flexible part of the container facing the transfer film to pressurize the transfer film.

The method thus characterized depressurizes the interior of the container containing the base material and the transfer film disposed on each other, inviting a flexible part of the container facing the transfer film to closely adhere to and pressurize the transfer film by atmospheric pressure. The transfer film may be accordingly pushed against the base material (the three-dimensional layer formed thereon) to readily and successfully transfer the transfer layer to the surface of the three-dimensional layer.

The layered-body production method according to this invention is preferably further characterized in that the transfer layer includes any one selected from the group consisting of a metallic layer, a hologram film layer, a pigmented layer, a white layer, a transparent layer, a fluorescent layer, a luminous layer, and a stealth ink layer.

This may successfully provide a layered body with the transfer layer selected from the following examples transferred thereto; a metallic layer, a hologram film layer, a pigmented layer, a white layer, a transparent layer, a fluorescent layer, a luminous layer, and a stealth ink layer.

### Effects of the Invention

According to this invention, the transfer layer may be transferred well to the three-dimensionally layered ink, and the transfer printing may be performed more efficiently.

### BRIEF DESCRIPTION OF THE DRAWINGS

FIG. 1 is a schematic drawing that illustrates a three-dimensional layer forming step of a layered-body production method according to an embodiment (first embodiment) of this invention.

FIG. 2 is a schematic drawing that illustrates curing of a three-dimensional layer in the three-dimensional layer forming step of the layered-body production method according to the embodiment (first embodiment) of this invention.

FIGS. 3(a)-3(d) are schematic drawings that illustrate a smoothing step of the layered-body production method according to the embodiment (first embodiment) of this invention.

FIG. 4 is a schematic drawing that illustrates a smoothing step of the layered-body production method according to the embodiment (first embodiment) of this invention.

FIG. 5 is a schematic drawing that illustrates a smoothing step of a layered-body production method according to a modified example of the embodiment (first embodiment) of this invention.

FIG. 6 is a schematic drawing that illustrates a transfer step of the layered-body production method according to the embodiment (first embodiment) of this invention.

FIGS. 7(a)-7(b) are schematic drawings that illustrate the transfer step of the layered-body production method according to the embodiment (first embodiment) of this invention and a modified example thereof.

FIG. 8 is a schematic drawing that illustrates a completed state when the layered-body production method according to the embodiment (first embodiment) of this invention is over.

FIG. 9 is a schematic drawing that illustrates applying a color ink on a layered body produced by the method according to the embodiment (first embodiment) of this invention.

FIG. 10 is a schematic drawing that illustrates a layered body according to the embodiment (first embodiment) of this invention.

FIG. 11 is a schematic drawing that illustrates an adhesive layer forming step of a layered-body production method according to an embodiment (second embodiment) of this invention.

FIG. 12 is a schematic drawing that illustrates a transfer step of the layered-body production method according to the embodiment (second embodiment) of this invention.

FIGS. 13(a)-13(b) are schematic drawings that illustrate the transfer step of the layered-body production method according to the embodiment (second embodiment) of this invention and a modified example thereof.

FIG. 14 is a schematic drawing that illustrates a completed state when the layered-body production method according to the embodiment (second embodiment) of this invention is over.

FIG. 15 is a schematic drawing that illustrates a transfer step of a layered-body production method according to an embodiment (third embodiment) of this invention.

FIG. 16 is a schematic drawing that illustrates a completed state when the layered-body production method according to the embodiment (third embodiment) of this invention is over.

FIG. 17 is a schematic drawing that illustrates a transfer step of a layered-body production method according to an embodiment (fourth embodiment) of this invention.

FIG. 18 is a schematic drawing that illustrates a completed state when the layered-body production method according to the embodiment (fourth embodiment) of this invention is over.

### EMBODIMENTS OF THE INVENTION

### First Embodiment

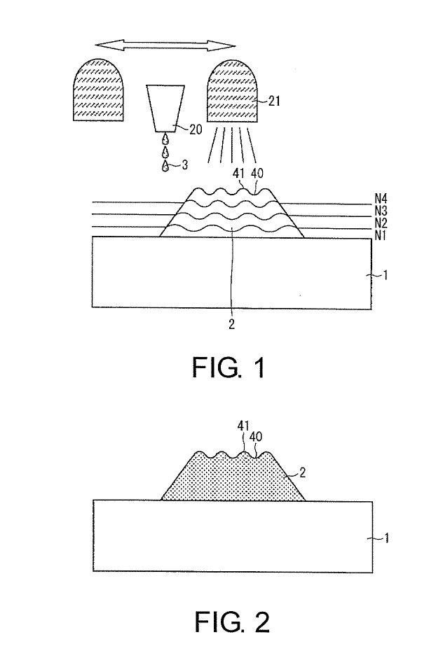

An embodiment of this invention (first embodiment) is hereinafter described referring to FIGS. 1 to 8. The embodiment of this invention relates to a method for producing a layered body 9 including layers of a base material 1, a three-dimensional layer 2, and a metallic layer 7. This embodiment carries out the steps hereinafter described for the base material 1 to finally produce the layered body 9. Examples of the base material 1 include but are not limited to a flat or film-like substrate, materials of which are a plastic molded material, SUS, metals including brass, glass, stones, or fabrics.

(Three-Dimensional Layer Forming Step)

The layered-body production method according to the embodiment of this invention starts with a three-dimensional layer forming step. FIG. 1 is a schematic drawing that illustrates the three-dimensional layer forming step of the layered-body production method according to this embodiment. FIG. 2 is a schematic drawing that illustrates curing of a three-dimensional layer in the three-dimensional layer forming step. As illustrated in FIG. 1, the three-dimensional layer forming step, using an ink jet head 20, applies (discharges) a UV ink (curable ink) 3 curable by ultraviolet light (may be hereinafter referred to as “UV) radiation on the base material 1 to form the three-dimensional layer 2.

The three-dimensional layer forming step further irradiates the UV ink 3 applied on the base material 1 with ultraviolet light emitted from a UV lamp (ultraviolet irradiation device) 21. This step, by way of ultraviolet light radiation, cures the UV ink 3 applied on the base material 1, thereby forming the three-dimensional layer 2.

The UV ink 3 may be any ink containing the ultraviolet curable resin, for example, a solvent-diluted UV ink additionally containing a solvent. The color of the UV ink 3 may be selected from colors suitable for the type of the base material 1 and intended use of a printed material to be obtained, as exemplified by such colors as clear (transparent), white, and black. The ink usable to form the three-dimensional layer 2 is not necessarily limited to the UV ink 3 but may be non-limitingly any ink primarily including solid matter with fewer volatile constituents. For example, the UV ink 3 may be suitably replaced with a latex ink prepared such that approximately 5 wt. % to 20 wt. % of solid matter is included therein. This method, by simply applying the solid matter-containing UV ink 3 on the base material 1, may form the three-dimensional layer 2 three-dimensionally structured on the base material 1 without the need to additionally prepare a mold and the like. Examples of the UV ink 3 may be UV inks containing, as the ultraviolet curable resin, acrylic multifunctional monomers. An example of the UV inks containing acrylic multifunctional monomers is a product with the trade name “LH-100”, available from MIMAKI ENGINEERING CO., LTD.

The UV ink 3, though may be applied just once, may be preferably applied a plurality of times to deposit the UV ink 3 in layers. How many times the UV ink 3 should be applied may be optionally decided in perspective of its targeted three-dimensional structure, height, and shape. For example, the UV ink 3 may be applied in four stages illustrated with N1 to N4 in FIG. 1. The three-dimensional layer 2 formed in multiple layers may have a larger freedom in shape. The shape of the three-dimensional layer 2 may be accordingly presented in more stereoscopic depth. A shape formed by one discharge of the UV ink 3 should desirably represent a shape in cross section of one layer obtained by dividing a whole three-dimensional shape to be consequently formed of the three-dimensional layer 2 by a height of each three-dimensional shape formed by one discharge of the UV ink 3.

In the process of applying the UV ink 3 plural times to be stacked in layers, the UV ink 3, every time it is applied on the base material 1, is irradiated with ultraviolet light emitted from the UV lamp 21. The UV ink 3 may be cured every time it is applied on the base material 1. This may facilitate the formation of the three-dimensional layer 2 in any desirable three-dimensional structure, height, and shape.

Preferably, the UV ink 3 on the base material 1, while being discharged from the ink jet head 20 on the base material 1, is irradiated with ultraviolet light emitted from the UV lamp 21, as illustrated in FIG. 1. Thus, applying and curing the UV ink 3 are performed substantially concurrently, so that the three-dimensional layer 2 may be formed in a shorter period of time. The UV ink 3, if cured immediately after being deposited on the base material 1, may be cured before it even starts to flow. This may involve the risk of producing irregularities on the surface of the three-dimensional layer 2, as illustrated in FIG. 1.

If the metallic layer 7 is transferred to the surface of the three-dimensional layer 2 with depressions 40 and projections 41 formed thereon, the metallic layer 7 formed on these depressions and projections consequently have a roughened surface. Another problem is that the roughened surface of the metallic layer 7 is not as glossy as expected.

The layered-body production method according to this embodiment performs a smoothing step hereinafter described in order to obtain an image superior in glossiness and presenting a three-dimensional effect after the metallic layer 7 is transferred to the surface of the three-dimensional layer 2.

(Smoothing Step)

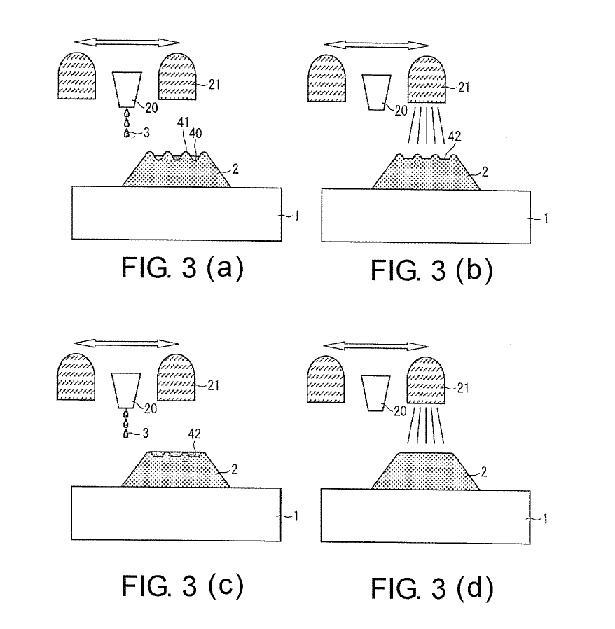

After the three-dimensional layer 2 is formed in the three-dimensional layer forming step, the smoothing step is performed. FIGS. 3(a)-3(d) are schematic drawings that illustrate the smoothing step according to this embodiment. As illustrated FIG. 3(a), the ink jet head 20 is scanned to apply the UV ink containing a curable resin (liquid containing solid matter) 3 on the surface of the three-dimensional layer 2 with irregularities formed thereon. The applied UV ink 3 is left at rest for a certain period of time to promote the UV ink 3 to flow on the surface of the three-dimensional layer 2. Then, the UV ink 3 on the projections 41 flows toward and retained in the depressions 40. This may lower the degree of surface roughness of the three-dimensional layer 2. The period of time when the applied UV ink 3 is left at rest may be optionally decided depending on the viscosity and quantity of the UV ink 3.

Then, as illustrated in FIG. 3(b), the UV ink 3 spread on the surface of the three-dimensional layer 2 whose irregularities are lessened (yet to be smoothed) is irradiated with ultraviolet light emitted from the UV lamp 21 to cure the UV ink 3. As a result, the three-dimensional layer 2 whose surface has a lower degree of roughness may be formed.

As illustrated in FIG. 3(c), the ink jet head 20 is scanned to apply the UV ink 3 on the surface of the three-dimensional layer 2 still with irregularities. Then, the UV ink 3 deposited on the surface flows toward and retained in the depressions 42. This may further lower the degree of roughness of the surface of the three-dimensional layer 2, finally smoothing the irregularities on the surface.

As illustrated in FIG. 3(d), the smoothed surface of the three-dimensional layer 2 is irradiated with ultraviolet light to cure the UV ink 3 retained in the depressions 42. As a result, the three-dimensional layer 2 whose surface has been smoothed out may be obtained.

The smoothing step according to this embodiment performs twice a processing cycle consisting of applying the UV ink 3 on the surface of the three-dimensional layer 2 and irradiating the UV ink 3 with ultraviolet light to cure the UV ink 3, which is, however, a non-limiting example. This processing cycle may be performed three times or more. By performing the process more than once, the irregularities formed on the surface of the three-dimensional layer 2 may be lessened by degrees. In the end, all of the irregularities on the surface of the three-dimensional layer 2 may disappear.

By performing the described step more than once to smooth the irregularities on the surface of the three-dimensional layer 2, the UV ink 3 discharged in one round of the step repeatedly performed may be reduced as compared to the UV ink 3 discharged in the step performed just once to smooth the surface of the three-dimensional layer 2. This may reduce the ink to be irradiated with ultraviolet light at a time, allowing the use of ultraviolet light with a weaker intensity to cure the UV ink 3. This may be a great advantage that prevents sink marks (dents formed on surface by curing-induced volume shrinkage) that may otherwise be formed on the surface of the three-dimensional layer 2.

The smoothing step according to this embodiment may perform plural times a processing cycle consisting of applying twice or more the UV ink 3 on the surface of the three-dimensional layer 2 and irradiating once the UV ink 3 with ultraviolet light to cure the UV ink 3. For example, the smoothing step according to this embodiment may perform twice the processing cycle consisting of applying twice the UV ink 3 on the surface of the three-dimensional layer 2 and irradiating once the UV ink 3 with ultraviolet light to cure the UV ink 3. Thus, the smoothing step subsequent to the three-dimensional layer forming step consequently applies the UV ink four times in total. This may reliably smooth the irregularities on the surface of the three-dimensional layer 2.

In the smoothing step according to this embodiment, the ink jet head 20 discharges, on the three-dimensional layer 2, the UV ink 3 in a quantity required to smooth the irregularities formed on the surface of the three-dimensional layer 2. This may prevent excess or shortage (not enough to smooth the irregularities on the surface of the three-dimensional layer 2) of the UV ink 3 applied on the three-dimensional layer 2.

The degree of roughness of the surface of the three-dimensional layer 2 is variable with conditions including the viscosity of the UV ink 3, quantity of the UV ink 3 discharged on the base material 1 in the three-dimensional layer forming step, and/or height of the three-dimensional layer 2 formed in the three-dimensional layer forming step. The quantity of the UV ink 3 necessary for smoothing the irregularities formed on the surface of the three-dimensional layer 2 is suitably decided in view of such conditions.

According to this invention, such terms as “smoothed” and “smoothing” may not only refer to the surface flattened by making any projections or depressions disappear from the surface of the three-dimensional layer 2 but also refer to the surface substantially flattened by making as many projections or depressions as possible disappear from the surface of the three-dimensional layer 2.

### MODIFIED EXAMPLE

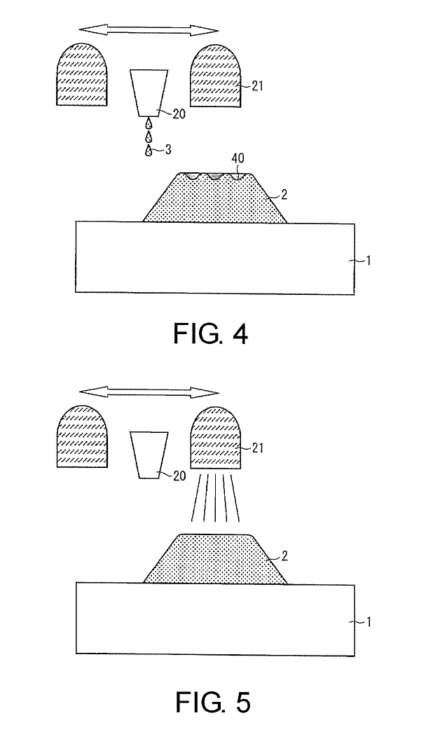

The smoothing step according to the first embodiment performs twice the processing cycle consisting of applying the UV ink 3 on the surface of the three-dimensional layer 2 and irradiating the UV ink 3 with ultraviolet light to cure the UV ink 3. However, performing this processing cycle once is included in the scope of this invention. Smoothing the irregularities formed on the surface of the three-dimensional layer 2 by performing the processing cycle once is hereinafter described referring to FIGS. 4 and 5.

FIGS. 4 and 5 are schematic drawings that illustrate the smoothing step according to the modified example of the embodiment. As illustrated in FIG. 4, the curable resin-containing UV ink 3 is applied on the surface of the three-dimensional layer 2 to smooth the irregularities formed thereon. As illustrated in FIG. 5, when the surface of the three-dimensional layer 2, with its degree of roughness being gradually lowered, is finally smoothed, the UV ink 3 on the surface is then irradiated with ultraviolet light emitted from the UV lamp 21 to be cured. As a result, the three-dimensional layer 2 whose surface has been smoothed may be formed.

(Transfer Step)

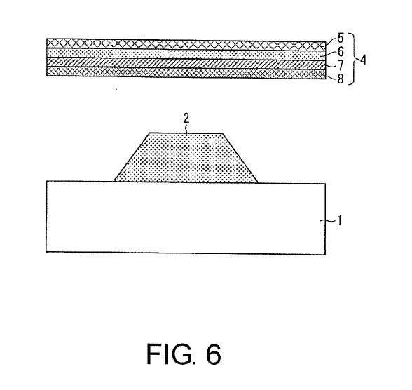

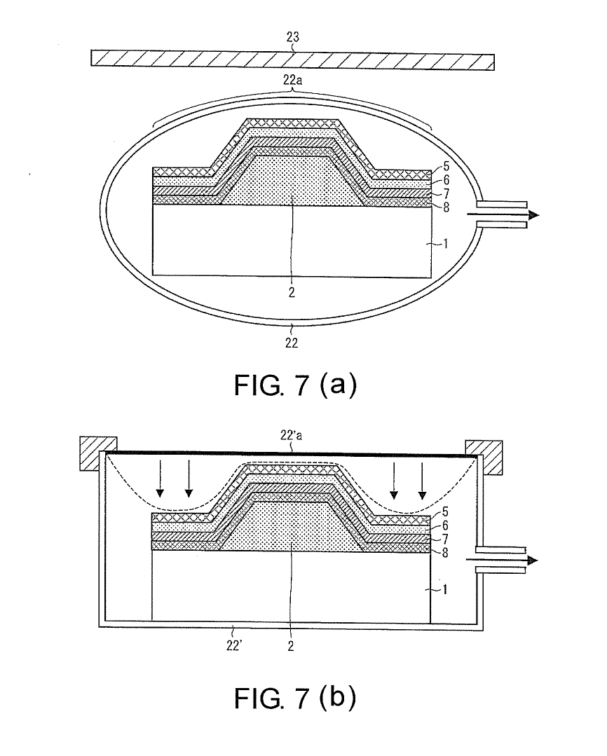

Then, the method proceeds to a transfer step. FIGS. 6 and 7(a)-7(b) are schematic drawings that illustrate the transfer step according to this embodiment. The transfer step according to this embodiment is performed with the use of a transfer film 4 as exemplified by the illustration of FIG. 6. The transfer film 4 includes a release layer 6, a metallic layer 7, and an adhesive layer 8 stacked in layers on a base film 5 in this order. Of these layers, the metallic layer 7 is a transfer layer to be transferred in the transfer step according to this embodiment.

The metallic layer 7 may be a metallic foil fixed on the release layer 6 or a metallic film, such as an aluminum film, formed on the release layer 6 by vapor deposition or sputtering. The surfaces of metallic layer 7 may be subjected to matting treatment beforehand depending on an intended use.

The transfer layer to be transferred in the transfer step is not necessarily limited to the metallic layer 7. The transfer layer may be optionally selected from a hologram film layer, a pigmented layer using a pigment or a die, a white layer, a transparent layer (including a semi-transparent layer), a fluorescent layer, a luminous layer, and a stealth ink layer. The transfer layer may be a metallic layer further including a pigmented layer in a color(s) and/or with a pattern(s). Adding such a pigmented layer may impart, instead of just metallic glossiness rather monotonous, variously different colors, patterns, and/or letters/characters to the metallic layer. The metallic layer 7 per se may be pigmented in a color(s) or decorated with a pattern(s).

The base film 5 is a film to support the metallic layer 7. The release layer 6 is for temporary fixing of the metallic layer 7 on the base film 5. The release layer 6 holds the metallic layer 7 until the metallic layer 7 is adhered to the three-dimensional layer 2. The adhesive layer 8 is an adhesive layer including a hot-melt adhesive containing a thermoplastic resin.

As illustrated in FIG. 7(a), the transfer film 4 is disposed on the base material 1 (with one on top of the other so that the three-dimensional layer 2 and the adhesive layer 8 face each other) and then placed in a plastic bag (bag) 22. According to this embodiment, the plastic bag 22 may be formed of a heat-resistance film made from, for example, fluororesins, polypropylene, oriented PET, or vinylidene chloride resins.

Then, the interior of the plastic bag 22 is depressurized by, for example, a vacuum pump. Then, the transfer film 4 is closely adhered by atmospheric pressure to the base material 1 with the three-dimensional layer 2 formed thereon. The plastic bag 22 thus depressurized inside closely contacts the base material 1 and the transfer film 4 as in vacuum packing, tightly wrapping the base material 1 and the transfer film 4. Then, a part 22a of the plastic bag 22 facing the transfer film 4 pressurizes the transfer film 4, pushing the transfer film 4 against the base material 1. In the state described above, the adhesive layer 8 is heated by a heater 23 such as an infrared heater until a temperature higher than or equal to the melting point or softening point of the adhesive layer 8 is reached. The adhesive layer 8 thus heated is then cooled down. In this manner, the adhesive layer 8 may be thermally flowed and then cured, allowing the base material 1 (three-dimensional layer 2 formed thereon) and the metallic layer 7 to adhere to each other. The surface of the three-dimensional layer 2, which has been smoothed by that time, may effectuate close contact between the three-dimensional layer 2 and the metallic layer 7 with the adhesive layer 8 interposed in the middle. Further advantageously, the metallic layer 7 has a smooth surface.

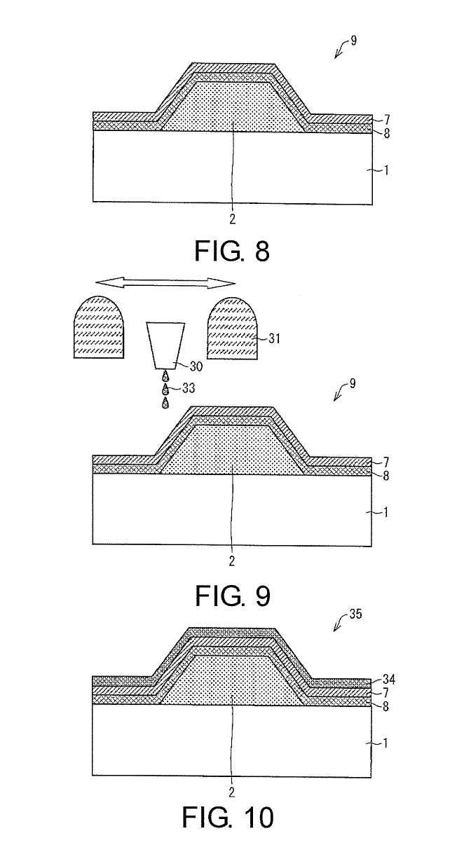

Then, the plastic bag 22 ceases to be depressurized, and the base material 1 is taken out of the plastic bag 22. The base film 5 is peeled off to release the metallic layer 7 from the release layer 6. Then, the layered body 9 having the metallic layer 7 formed on the base material 1 (on the three-dimensional layer 2 formed thereon) is finally obtained as illustrated in FIG. 8.

The plastic bag 22 may be replaced with a container 22′ having in a part thereof such a flexible film as illustrated in FIG. 7(b). This container 22′ may enable pressure fitting of the layers by way of pressure reduction. The container 22′ has a part 22′a formed of, for example, a flexible film. The base material 1 and the transfer film 4 disposed on each other with the part 22′a facing the transfer film 4 is placed in the container 22′. Then, the interior of the container 22′ is depressurized by, for example, a vacuum pump. Then, the transfer film 4 is closely adhered by atmospheric pressure to the base material 1 with the three-dimensional layer 2 formed thereon. By depressurizing the interior of the container 22′, the flexible part 22′a closely contacts the transfer film 4, pressurizing the transfer film 4 as illustrated in FIG. 7(b) (illustrated with a dotted line in FIG. 7(b)). Similarly to the use of the plastic bag 22, the transfer film 4 is pushed against the base material 1. Then, heating and cooling are performed to ensure firm adhesion between the base material 1 (the three-dimensional layer 2 formed thereon) and the metallic layer 7.

The transfer step according to this embodiment depressurizes the interior of the plastic bag 22 using a vacuum pump for adhesion between the three-dimensional layer 2 and the metallic layer 7 (vacuum transfer). This is, however, a non-limiting example, and may be replaced with other means. For example, the metallic layer 7 may be pushed against the three-dimensional layer 2 by means of a roller, a pad, or a brush for adhesion between the three-dimensional layer 2 and the metallic layer 7, or other transfer methods may be optionally selected and used.

According to this embodiment, the smoothing step applies the UV ink 3 on the three-dimensional layer 2 to smooth the irregularities formed on the surface of the three-dimensional layer 2 and then cures the UV ink. When the smoothing step is over, therefore, the three-dimensional layer 2 may have a smoothed surface. By pushing the transfer film 4 including the metallic layer 7 against the smoothed surface of the three-dimensional layer 2, the metallic layer 7 may be closely adhered to the three-dimensional layer 2 and accordingly transferred well to the surface of the three-dimensional layer 2. This may ensure firm adhesion between the three-dimensional layer 2 and the metallic layer 7. The surface of the transferred metallic layer 7 has a smooth surface with no projection or depression formed thereon. This may provide an image that excels in glossiness.

In the manner described so far, the metallic layer may be favorably transferred to the surface of the three-dimensionally layered ink with an improved transfer efficiency.

According to the method described above eliminating the need to prepare a mold and the like, an image presenting a three-dimensional effect may be formed with lower cost or within shorter delivery time.

According to this embodiment, the UV ink 3 contains no solvent and primarily consists of an ultraviolet curable resin as solid matter by substantially 100%. After the UV ink 3 is discharged on the three-dimensional layer 2, therefore, the ingredients of the UV ink 3 are not possibly volatilized. This may allow for speedy smoothing of the irregularities, improving the efficiency of producing the layered body.

According to this embodiment, the production of the layered body 9 employs an ink jet recording device structured to have the UV lamp 21 and the ink jet head 20 attached to the carriage driven in a scan direction (not illustrated in the drawings). This is, however, a non-limiting example of the production method. The scope of this invention may include the production of the layered body 9 without using such an ink jet recording device. Instead of using the ink jet recording device, the smoothing step may employ, for example, doming (dome-like coating using resin).

Next, the formation of a color ink layer 34 by applying a color ink to the metallic layer 7 is described referring to FIGS. 9 and 10. FIG. 9 is a schematic drawing that illustrates applying a colored ink on the layered body produced by the method according to the embodiment. FIG. 10 is a schematic drawing that illustrates the layered body according to the embodiment of this invention. As illustrated in FIG. 9, a UV color ink 33 curable by ultraviolet light radiation is applied by an ink jet head 30 on the metallic layer 7 transferred by the method according to this embodiment.

Next, the applied UV color ink 33 is irradiated with ultraviolet light emitted from a UV lamp 31 to form the color ink layer 34 on the metallic layer 7. This may provide a layered body 35 having a metallic color image in which the color ink layer 34 is formed on the metallic layer 7.

The UV color ink 33 may be any color ink containing an ultraviolet curable resin, for example, a solvent-diluted UV color ink additionally containing a solvent. The color of the UV color ink 33 may be selected from colors suitable for the type of the base material 1 and an intended use, as exemplified by such colors as clear (transparent), white, and black.

### Second Embodiment

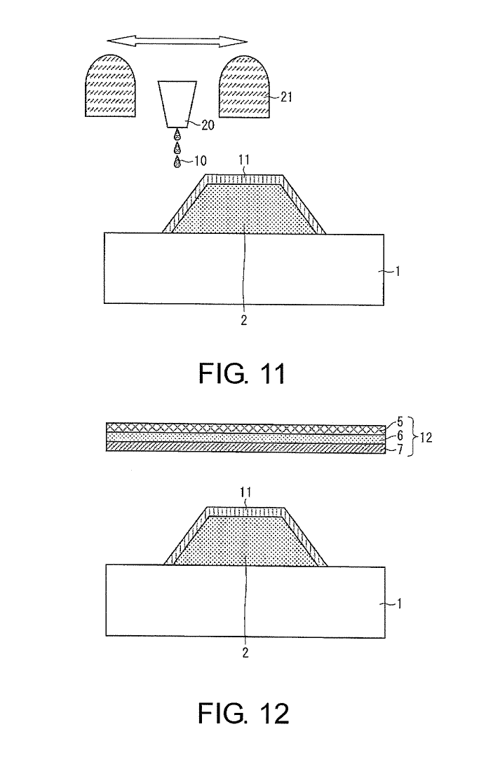

An embodiment of this invention (second embodiment) is hereinafter described referring to FIGS. 11 to 14. A layered-body production method according to this embodiment performs the three-dimensional layer forming step and the smoothing step as with the first embodiment. This method additionally performs an adhesive layer forming step between the smoothing step and the transfer step.

(Adhesive Layer Forming Step)

As illustrated in FIG. 11, the adhesive layer forming step according to this embodiment applies an UV adhesive ink 10 using the ink jet head 20 on the three-dimensional layer 2 formed on the base material 1. The UV adhesive ink 10 is not particularly limited as far as it contains an ultraviolet curable resin such as a cationic polymerizable or radically polymerizable ultraviolet curable resin. Then, the UV adhesive ink 10 is irradiated with ultraviolet light with a controlled intensity emitted from the UV lamp 21 and thereby semi-cured to form the adhesive layer 11. The ultraviolet light radiation may be omitted, in which case the application of the UV adhesive ink 10 may directly form the adhesive layer 11.

Then, the method proceeds to a transfer step. The transfer step according to this embodiment uses a transfer film 12. As illustrated in FIG. 12, the transfer film 12 includes a release layer 6 and a metallic layer 7 stacked in layers on a base film 5. The transfer film 12 according to this embodiment has no adhesive layer.

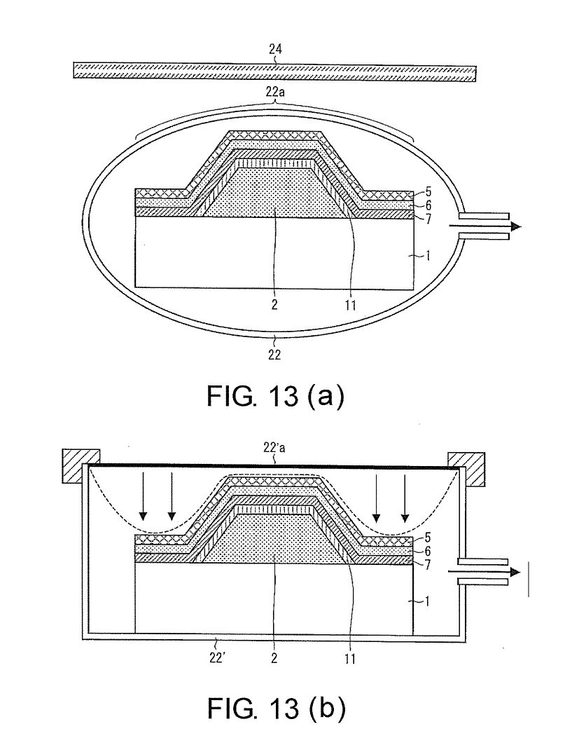

As illustrated in FIG. 13(a), the transfer film 12 is disposed on the base material 1 (with one on top of the other so that the adhesive layer 11 and the metallic layer 7 face each other). Then, these layers are placed in the plastic bag (container) 22, and the interior of the plastic bag 22 is depressurized as with the first embodiment. The plastic bag 22 according to this embodiment may be an ultraviolet permeable plastic bag. The material of the plastic bag 22 may include but is not limited to polyethylene, polypropylene, polyester, polyimide, polyamide, silicone rubber, and polyisoprene rubber.

By depressurizing the interior of the plastic bag 22, the part 22a of the plastic bag 22 facing the transfer film 4 pressurizes the transfer film 4, providing close contact between the three-dimensional layer 2 and the metallic layer 7 with the adhesive layer 11 interposed in the middle. Then, these closely contacting layers are irradiated with ultraviolet light emitted from a UV lamp 24 to fully cure the adhesive layer 11. The three-dimensional layer 2 and the metallic layer 7 are accordingly adhered to each other. Referring to FIG. 13(a), ultraviolet irradiation is directed toward the transfer film 12. Alternatively, ultraviolet irradiation may be directed toward the base material 1 if the base material 1 is made of an ultraviolet-permeable material.

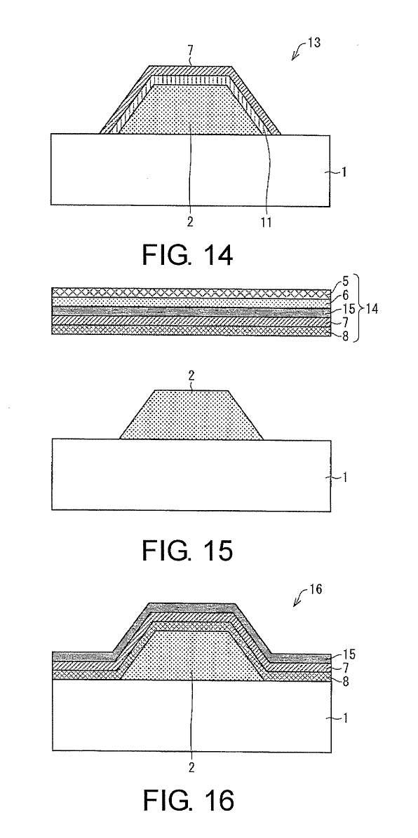

Then, the plastic bag 22 ceases to be depressurized, and the base material 1 is taken out of the plastic bag 22. The base film 5 is peeled off to release the metallic layer 7 from the release layer 6. Then, the layered body 13 having the metallic layer 7 formed on the base material 1 (on the three-dimensional layer 2 formed thereon) is finally obtained as illustrated in FIG. 14. Similarly to the first embodiment, the plastic bag 22 may be replaced with the container 22′ having in a part thereof a flexible film as illustrated in FIG. 13(b).

Unlike the first embodiment, this embodiment transfers the metallic layer 7 to only a part where the adhesive layer 11 is formed (on the three-dimensional layer 2 alone) as illustrated in FIG. 14. Possibly, the transfer film 12 is thermally deformed or accidentally displaced due to some factor. If such events occur, the metallic layer 7 is neither adhered nor transferred to any part on which the adhesive layer 11 is not formed. Therefore, the metallic layer 7 may be transferred precisely onto the adhesive layer 11 alone which is formed on the three-dimensional layer 2. By applying the UV adhesive ink 10 by, for example, ink jet technique, the adhesive layer 11 may be precisely formed at an intended position. This leads to a better precision with a transfer position of the metallic layer 7.

### MODIFIED EXAMPLE

The adhesive used to form the adhesive layer 11 is not necessarily limited to the UV adhesive ink 10 but may be selected from other adhesives. An example of the usable adhesives is a hot-melt adhesive containing a thermoplastic resin. In the transfer step using such an adhesive, the adhesive layer 11 is heated by means of the heat-resistant plastic bag 22 and the heater 23 until a temperature higher than or equal to the melting point or softening point of the adhesive layer 11 is reached. The adhesive layer 11 thus heated is then cooled down. In this manner, the three-dimensional layer 2 and the metallic layer 7 may be adhered to each other.

### Third Embodiment

The transfer film 4 used in the first embodiment may be replaced with such a transfer film 14 as illustrated in FIG. 15. The transfer film 14 is different from the transfer film 4 in that a protective layer 15 is interposed between the release layer 6 and the metallic layer 7. In the transfer step, the protective layer 15, as well as the metallic layer 7, is transferred by means of the transfer film 14 so that the protective layer 15 is formed on the metallic layer 7 on the opposite side of the three-dimensional layer 2. Then, a layered body 16 in which the metallic layer 7 is coated with the protective layer 15 may be finally obtained as illustrated in FIG. 16. The metallic layer 7 thus coated with the protective layer 15 may be protected against scratches, being tainted with fingerprints, alcohol, water, and/or ultraviolet light. Further, the protective layer 15, if colored and/or decorated with a pattern(s), may contribute to a more expressive image.

### Fourth Embodiment

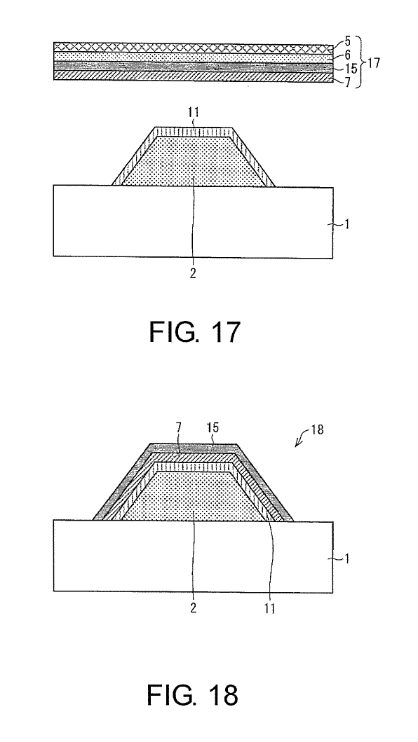

The transfer film 12 used in the second embodiment may be replaced with such a transfer film 17 as illustrated in FIG. 17. The transfer film 17 is different from the transfer film 12 in that a protective layer 15 is interposed between the release layer 6 and the metallic layer 7. In the transfer step, the protective layer 15, as well as the metallic layer 7, is transferred by means of the transfer film 17 so that the protective layer 15 is formed on the metallic layer 7 on the opposite side of the three-dimensional layer 2. Then, a layered body 18 in which the metallic layer 7 is coated with the protective layer 15 may be finally obtained as illustrated in FIG. 18. The metallic layer 7 thus coated with the protective layer 15 may be protected against scratches, being tainted with fingerprints, alcohol, water, and/or ultraviolet light. Further, the protective layer 15, if colored and/or decorated with a pattern(s), may contribute to a more expressive image.

### First Modified Example

According to the embodiments described so far, the same UV ink is used in both of the three-dimensional layer forming step and the smoothing step. This invention includes in its scope other options. Specifically, the solid matter-containing ink applied on the base material in the three-dimensional layer forming step may be different from the solid matter-containing liquid applied on the surface of the three-dimensional layer in the smoothing step. The solid matter-containing liquid is not necessarily limited as far as the irregularities formed on the surface of the three-dimensional layer may be smoothed in the smoothing step.

The solid matter-containing liquid may be a liquid lower in viscosity than the solid matter-containing ink. Examples of the solid matter-containing ink may include inks containing acrylic multifunctional monomers. Examples of the solid matter-containing liquid may include liquids containing acrylic monofunctional monomers. An example of the inks containing acrylic multifunctional monomers is the product, “LH100” mentioned earlier. An example of the liquids containing acrylic monofunctional monomers is a product with the trade name “PR-100”, available from MIMAKI ENGINEERING CO., LTD.

The liquids containing acrylic monofunctional monomers are advantageous in that their tackiness is not lost even when fully cured. When any of such liquid is used in the smoothing step, the adhesive layer described in the embodiments described so far is no longer necessary. Without the adhesive layer, the three-dimensional layer and the transfer film may be adhered well to each other. Any one selected from the exemplified liquids containing acrylic monofunctional monomers, instead of being fully cured in the smoothing step, may be fully cured in a step later.

### Second Modified Example

According to the embodiments described so far, in the smoothing step, the UV ink 3 is used as the solid matter-containing liquid and applied on the surface of the three-dimensional layer 2 to smooth the irregularities formed thereon. The solid matter-containing liquid is not necessarily limited to such a UV ink. The solid matter-containing liquid may be selected from thermosetting inks containing thermosetting resins curable by heating, in which case any known thermosetting resins may be used.

When using a thermosetting ink as the solid matter-containing liquid, the thermosetting ink is cured by, for example, a heater in the smoothing step. Then, a three-dimensional layer with no projection or depression formed on its surface may be obtained. When discharging the thermosetting ink from an ink jet head on the surface of the three-dimensional layer, an ink jet head may be prepared in addition to the ink jet head that discharges the UV ink, or the thermosetting ink may be discharged through a discharge port different from a discharge port for discharge of the UV ink.

### Third Modified Example

The solid matter-containing liquid according to this invention, instead of the UV ink or thermosetting ink, may be a solvent-containing liquid (for example, a solvent ink). The three-dimensional layer 2, after the solvent-containing liquid is applied on its surface, is heated. This heating volatilizes the solvent, while leaving the solid matter unvolatilized, serving to smooth the irregularities formed on the surface of the three-dimensional layer 2. In the case where the liquid contains a large quantity of solvent, such a large quantity of solvent in the liquid applied on the three-dimensional layer 2 is volatilized by heating the three-dimensional layer 2. To effectively smooth the irregularities on the surface of the three-dimensional layer 2, applying the liquid and volatilizing the solvent are repeatedly performed to smooth the irregularities by degrees.

The implementations of this invention are not necessarily limited to the embodiments described so far and may be carried out in many other forms. The technical scope of this invention encompasses any modifications within its scope defined by the appended claims and embodiments obtained by variously combining the technical means disclosed herein.

<Additional Points>

The layered-body production method according to any one of the first to fourth embodiments is a method for producing a layered body 9, 13, 16 or 18 including layers of a base material 1, a three-dimensional layer 2, and a transfer layer 7, the method including a three-dimensional layer forming step of applying an ink containing solid matter on the base material 1 to form the three-dimensional layer 2; a smoothing step of applying a liquid containing solid matter at least once on the three-dimensional layer 2 to smooth irregularities formed on a surface of the three-dimensional layer 2; a transfer step of pushing a transfer film 4, 12, 14 or 17 including the metallic layer 7 against the surface of the three-dimensional layer 2 subsequent to the smoothing step to transfer the metallic layer 7 to the surface of the three-dimensional layer 2.

The method thus characterized, by simply applying the ink containing solid matter on the base material 1, may form the three-dimensional layer 2 three-dimensionally structured on the base material 1 without the need to additionally prepare a mold and the like.

If the three-dimensional layer 2 has projections and depressions on its surface when the three-dimensional layer forming step is over, pushing the transfer film 4, 12, 14 or 17 including the metallic layer 7 against the three-dimensional layer 2 fails in complete transfer of the metallic layer 7. This is fraught with the following problems. On the surface of the three-dimensional layer 2, the transfer of the metallic layer 7 on their projections 41 goes well, whereas the transfer of the metallic layer 7 on their depressions 42 substantially fails. Supposing that the transfer of the metallic layer 7 does not fail, a high-quality transferred material may be hardly expected.

According to the method described above, the smoothing step applies the solid matter-containing liquid at least once on the surface of the three-dimensional layer 2 to smooth the irregularities formed on the surface of the three-dimensional layer 2 before curing. When the smoothing step is over, therefore, the three-dimensional layer 2 may have a smoothed surface. By pushing the transfer film 4, 12, 14 or 17 including the metallic layer 7 against the smoothed surface of the three-dimensional layer 2, the metallic layer 7 may be closely adhered to the three-dimensional layer 2 and accordingly transferred well to the surface of the three-dimensional layer 2. This may provide an image in which the metallic layer 7 is firmly adhered to the three-dimensional layer 2. Further advantageously, there is accordingly no projection or depression formed on the surface of the transferred metallic layer 7, providing the metallic layer 7 with a smoothed surface.

According to the method described above eliminating the need to prepare a mold and the like, an image presenting a three-dimensional effect may be formed with lower cost or within shorter delivery time.

The layered-body production method according to any one of the first to fourth embodiments is further characterized in that the ink is the UV ink 3 containing the ultraviolet curable resin curable by ultraviolet light radiation, and the three-dimensional layer forming step includes forming the three-dimensional layer 2 by, while applying the UV ink 3 on the base material 1, irradiating the UV ink 3 applied on the base material 1 with ultraviolet light to cure the UV ink 3.

The method thus characterized may favorably form the three-dimensional layer 2 using the UV ink 3 containing the ultraviolet curable resin. Thus, applying and curing the UV ink 3 are performed substantially concurrently, so that the three-dimensional layer 2 may be formed in a shorter period of time.

The layered-body production method according to any one of the first to fourth embodiments is further characterized in that the carriage to be driven in a scan direction is mounted with the UV lamp 21 to irradiate the UV ink 3 with ultraviolet light, and the ink jet head 20 from which the UV ink 3 is to be discharged on the base material 1, and the three-dimensional layer forming step includes, while discharging the UV ink 3 from the ink jet head 20 on the base material 1, irradiating the UV ink 3 discharged on the base material 1 with ultraviolet light emitted from the UV lamp 21.

The method thus characterized, by using the ink jet head 20, may facilitate the formation of the three-dimensional layer 2 in any desired shape. The method may further advantageously facilitate concurrent discharge (applying) of the UV ink 3 and curing the curable ink.

The layered-body production method according to any one of the first to fourth embodiments is further characterized in that the liquid containing solid matter is the UV ink 3, and the smoothing step includes discharging, on the three-dimensional layer 2, the UV ink 3 from the ink jet head 20 in a quantity required to smooth the irregularities.

According to the method thus characterized, the ink jet head 20 discharges on the three-dimensional layer 2 the UV ink 3 in a quantity required to smooth the irregularities formed on the surface of the three-dimensional layer 2. This may ensure precise discharge of a predetermined quantity of the UV ink 3, preventing excess of the UV ink 3 on the three-dimensional layer 2, or shortage of the UV ink 3 that may fail in smoothing the irregularities on the surface of the three-dimensional layer 2. The method thus advantageous may form an image presenting a three-dimensional effect and having the metallic layer 7 closely adhered to the three-dimensional layer 2.

The UV ink 3 contains no solvent and primarily consists of the ultraviolet curable resin as solid matter by substantially 100%. After the UV ink 3 is discharged on the three-dimensional layer 2, therefore, the ingredients of the UV ink 3 are not possibly volatilized. This may allow for speedy smoothing of the irregularities, improving the efficiency of producing the layered body.

The layered-body production method according to any one of the first to fourth embodiments is further characterized in that the smoothing step includes irradiating the three-dimensional layer 2, after being smoothed, with ultraviolet light using the UV lamp 21.

According to the method thus characterized, the surface of the three-dimensional layer 2 smoothed by the UV ink 3 discharged from the ink jet head 20 is irradiated with ultraviolet light. By thus curing the UV ink 3 discharged on the surface of the three-dimensional layer 2, the three-dimensional layer 2 having a smoothed surface may be favorably formed.

The layered-body production method according to another embodiment of this invention is further characterized in that the smoothing step includes, after scan of the ink jet head 20 and discharge of the UV ink 3, performing a plurality of times a step of irradiating the UV ink 3 with ultraviolet light to cure the UV ink 3.

According to the method thus characterized, the smoothing step performs, after the UV ink 3 is discharged, performs the step of irradiating the UV ink 3 with ultraviolet light to cure the UV ink 3 not just once but a plurality of times. This may lessen by degrees the irregularities formed on the surface of the three-dimensional layer 2, ultimately smoothing the irregularities on the surface of the three-dimensional layer 2.

By performing the described step more than once to smooth the irregularities on the surface of the three-dimensional layer 2, the UV ink 3 discharged in one round of the step repeatedly performed may be reduced as compared to the UV ink 3 discharged in the step performed just once to smooth the surface of the three-dimensional layer 2. This may reduce the ink to be irradiated with ultraviolet light at a time, allowing the use of ultraviolet light with a weaker intensity to cure the UV ink 3. This may be a great advantage that prevents sink marks that may otherwise be formed on the surface of the three-dimensional layer 2.

The layered-body production method according to any one of the first to fourth embodiments is further characterized in that, in the transfer step, the base material 1 and the transfer film 4, 12, 14 or 17 disposed on each other are placed in a container (plastic bag 22 or container 22′) at least partly flexible and the interior of the container (plastic bag 22 or container 22′) is depressurized, so that the flexible part (part 22a of 22′a) of the container (plastic bag 22 or container 22′) facing the transfer film 4, 12, 14 or 17 pressurizes the transfer film 4, 12, 14 or 17.

The method thus characterized depressurizes the interior of the container (plastic bag 22 or container 22′) containing the base material 1 and the transfer film 4, 12, 14 or 17 disposed on each other, inviting the flexible part (part 22a of 22′a) of the container (plastic bag 22 or container 22′) facing the transfer film 4, 12, 14 or 17 to closely adhere to and pressurize the transfer film 4, 12, 14 or 17 by atmospheric pressure. The transfer film 4, 12, 14 or 17 may be accordingly pushed against the base material 1 (the three-dimensional layer 2 formed thereon) to readily and successfully transfer the metallic layer 7 to the surface of the three-dimensional layer 2.

The layered-body production method according to any one of the first to fourth embodiments is further characterized in that the transfer layer includes one selected from the group consisting of a metallic layer, a hologram film layer, a pigmented layer, a white layer, a transparent layer, a fluorescent layer, a luminous layer, and a stealth ink layer.

This may successfully provide the layered body 9, 13, 16 or 18 with the transfer layer selected from the following examples transferred thereto; a metallic layer, a hologram film layer, a pigmented layer, a white layer, a transparent layer, a fluorescent layer, a luminous layer, and a stealth ink layer.

### INDUSTRIAL APPLICABILITY

This invention is suitably applicable to fields relating to production of printed materials and manufacturing of printers.

### DESCRIPTION OF REFERENCE SIGNS

1 base material
2 three-dimensional layer
3 UV ink (curable ink, solid matter-containing liquid)
4,12,14,17 transfer film
5 base film
6 release layer
7 metallic layer (transfer layer)
8,11 adhesive layer
9,13,16,18,35 layered body
10 UV adhesive ink
11 protective layer
20,30 ink jet head
21,24,31 UV lamp
22 plastic bag (container)
22′ container
23 heater
33 UV color ink
34 color ink layer
40, 42 depressions
41 projections

1. A layered-body production method for producing a layered body including layers of a base material, a three-dimensional layer, and a transfer layer, the method comprising:
a three-dimensional layer forming step of applying an ink containing solid matter on the base material to form the three-dimensional layer;
a smoothing step of applying a liquid containing solid matter at least once on the three-dimensional layer to smooth irregularities formed on a surface of the three-dimensional layer; and
a transfer step of pushing a transfer film including the transfer layer against the surface of the three-dimensional layer subsequent to the smoothing step to transfer the transfer layer to the surface of the three-dimensional layer.

2. The layered-body production method according to claim 1, wherein
the ink is a curable ink containing an ultraviolet curable resin curable by ultraviolet light radiation, and
the three-dimensional layer forming step include:
forming the three-dimensional layer by, while applying the curable ink on the base material, irradiating the curable ink applied on the base material with ultraviolet light to cure the curable ink.

3. The layered-body production method according to claim 2, wherein
a carriage to be driven in a scan direction is mounted with an ultraviolet irradiation device to irradiate the curable ink with ultraviolet light, and an ink jet head from which the curable ink is to be discharged on the base material, and
the three-dimensional layer forming step includes: while discharging the curable ink from the ink jet head on the base material, irradiating the curable ink discharged on the base material with ultraviolet light emitted from the ultraviolet irradiation device.

4. The layered-body production method according to claim 3, wherein
the liquid containing solid matter is the curable ink containing the ultraviolet curable resin, and
the smoothing step includes: discharging on the three-dimensional layer the curable ink from the ink jet head in a quantity required to smooth the irregularities.

5. The layered-body production method according to claim 4, wherein
the smoothing step includes: irradiating the three-dimensional layer, after being smoothed, with ultraviolet light using the ultraviolet irradiation device.

6. The layered-body production method according to claim 5, wherein
the smoothing step includes: after scan of the ink jet head and discharge of the curable ink, performing a plurality of times a step of irradiating the curable ink with ultraviolet light to cure the curable ink.

7. The layered-body production method according to claim 1, wherein the transfer step includes:
disposing the base material and the transfer film on each other;
placing the base material and the transfer film disposed on each other in a container at least partly flexible; and
depressurizing interior of the container to force a flexible part of the container facing the transfer film to pressurize the transfer film.

8. The layered-body production method according to claim 1, wherein
the transfer layer includes one selected from the group consisting of a metallic layer, a hologram film layer, a pigmented layer, a white layer, a transparent layer, a fluorescent layer, a luminous layer, and a stealth ink layer.
